(19) United States
(12) Patent Application Publication
(10) Pub. No.: US 2025/0135549 A1
(43) Pub. Date: May 1, 2025

(54) DEVICE AND METHOD FOR RECYCLING SELECTIVE LASER MELTING GRADIENT POWDERS

(71) Applicant: JIANGSU UNIVERSITY, Zhenjiang (CN)

(72) Inventors: Chengyun CUI, Zhenjiang (CN); Panjie SUN, Zhenjiang (CN); Fuyu YE, Zhenjiang (CN); Xingyu WANG, Zhenjiang (CN); Lizhen WEI, Zhenjiang (CN); Xigui CUI, Zhenjiang (CN)

(73) Assignee: JIANGSU UNIVERSITY, Zhenjiang (CN)

(21) Appl. No.: 18/281,575

(22) PCT Filed: Apr. 28, 2023
(86) PCT No.: PCT/CN2023/091517

§ 371 Date: Aug. 2, 2024

(30) Foreign Application Priority Data
Jul. 13, 2022 (CN) 202210819499.3

(51) Int. Cl. B22F 10/73; B22F 10/28; B23K 26/34; B33Y 40/00

(52) U.S. Cl. CPC B22F 10/73; B23K 26/34; B33Y 40/00; B22F 10/28

(57) ABSTRACT

The present disclosure provides a device and method for recycling selective laser melting gradient powders, which comprises an ultrasonic powder suction device, a vertical support frame, the first vacuum pump, a sealing device, the second rotary motor, a powder storage bag, a vacuum box, a vibrating screen, a waste bin, the second vacuum pump, a powder conveying pipe, a cooling device, a water tank, and a spiral powder conveying pipe. This invention effectively reduces the risk of metal powder explosion through the cooling device's cooling. By multiple vibration screenings, this invention screens out the optimal gradient powders. The structure of this invention is simple, highly controllable, with easy-to-implement operating conditions, effectively avoiding the mixing and adhesion of different powders, improving the recovery utilization rate of gradient powders, and enabling the manufacturing of gradient materials with different compositions. It reduces contact with air in vacuum operation, and avoiding health hazards to workers caused by direct contact with powders.

### TECHNICAL FIELD

The present disclosure relates to the technical field of laser selective melting equipment, and in particular to a device and a method for recycling selective laser melting gradient powders.

### BACKGROUND

Selective laser melting (SLM) technology is a type of metal additive manufacturing technology, which was first proposed by the Fraunhofer Institute in Germany in 1985 and developed based on selective laser sintering (SLS) of metal powder. This technology uses a laser as an energy source to scan and melt metal powder layer by layer according to a predetermined path in a three-dimensional model. The melted and solidified metal powder forms metallurgical bonding, ultimately producing the metal part designed in the model. Compared with other additive manufacturing technologies, SLM technology has high melting and solidification speeds, and can produce parts with high complexity and precision, which has been successfully applied in aerospace, medical, mold-making, and other fields.

Functionally graded materials (FGM) refer to the materials whose composition, structure and properties differ in different positions. In practical engineering applications, the requirements for composition, structure and properties in different positions of the parts are different. Traditional SLM processing with the same material is insufficient to solve this problem. To address this issue, multiple materials can be used for rapid prototyping manufacturing as a solution. However, simultaneous rapid prototyping with multiple materials will cause difficulties in separating and recycling different powders.

The current selective laser melting powder recovery technology has a low powder recovery rate. It mainly relies on manual recycling, which is difficult and inefficient to recover, and is prone to pollution and waste. For metal powders, it is extremely dangerous to direct contact with air.

### SUMMARY

To solve the above-mentioned problems, one object of the present disclosure is to provide a device for recycling selective laser melting (SLM) gradient powders, which can separate and screening gradient powders, reducing contact with air by operating in vacuum, increasing the recycling rate of powders by reducing manual operations, and effectively preventing mixing and adhesion of different powders.

Another object of the present disclosure is to provide an ultrasonic powder suction device that can clean the un-melted powders inside the forming cylinder omni-directional and multi-perspective, effectively preventing mixing of different powders and increasing the powder recycling rate.

Another object of the present disclosure is to automatically identify metal powders and use a cooling device to reduce the risk of metal powder explosion.

Another object of the present disclosure is to provide a vacuum chamber, in which powder bags for storing and recycling powders are automatically sealed, reducing contact with air, increasing the efficiency of powder recycling, and avoiding health hazards to workers caused by direct contact with powders.

Another object of the present disclosure is to provide a method for recycling gradient powders from SLM using the device described above.

Note that the disclosure of these objects does not preclude the existence of other objects. One object of the present disclosure does not need to achieve all the above objects. Other objects of the present disclosure may be extracted from the specification, drawings, and claims.

The technical solution of the present disclosure is a selective laser melting gradient powder recovery device, including an ultrasonic powder suction device, a vertical support frame, a screening device, a waste material recovery device, a powder conveying pipe, a cooling device, and a controller.

The ultrasonic powder suction device is mounted on the vertical support frame. The vertical support frame is mounted on the printing platform. A top of the screening device is connected to the ultrasonic powder suction device through the powder conveying pipe, which has a helical powder conveying pipe with a cooling device. A metal powder sensor is installed in the helical powder conveying pipe, which is configured to detect whether the powder texture in the helical powder conveying pipe is metallic and send signals to the controller.

At least one screen mesh is installed inside the screening device to divide the shell into at least two areas, with an upper area connected to the waste material recovery device and a lowest area to the powder storage bag.

The controller is connected to the ultrasonic powder suction device, screening device, waste material recovery device, metal powder sensor, and cooling device, respectively.

The ultrasonic powder suction device includes the first rotary motor, the first telescopic motor, at least one suction hood, a flat powder suction head, an ultrasonic transducer, an ultrasonic generator, and a sleeve.

The first rotary motor is connected to the upper part of the sleeve to drive the sleeve to rotate. The flat powder suction head is connected to the lower part of the sleeve, and the telescopic motor is connected to the flat powder suction head to drive it to move up and down. The ultrasonic transducer is installed on the flat powder suction head, and the ultrasonic transducer is equipped with an ultrasonic generator. The suction hood is connected to the sleeve through the suction pipe, which is connected to the second telescopic motor, and the second telescopic motor is configured to drive the expansion and contraction of the suction pipe.

The suction hood includes the first suction hood and the second suction hood, which are installed on both sides of the sleeve, respectively.

The cooling device includes a water tank and a water pipe. The helical powder conveying pipe is located inside the water tank, and both ends of the helical powder conveying pipe are connected to the powder conveying pipe. The water tank is connected to the water pipe. A valve is provided on the water pipe, which is connected to the controller.

The screening device includes a shell and a vibration motor.

The shell is set with the first screen mesh and the second screen mesh, dividing the shell into the first area, the second area, and the third area from top to bottom, and the bore diameter of the first screen mesh is larger than that of the second screen mesh. The top of the shell is provided with a feed inlet. The shell has the first waste material outlet at the position of the first area and the second waste material outlet in the second area. The bottom of the shell is provided with a discharge outlet, which is connected to the powder storage bag. The vibration motor is mounted on the shell.

The above waste material recovery device includes a waste material tank and the second vacuum pump.

The waste material tank is connected to the first waste material outlet and the second waste material outlet of the screening device, and the second vacuum pump is connected to the waste material tank.

The scheme also includes a vacuum box, which is connected to the first vacuum pump.

The vacuum box is equipped with a sealing device, the second rotating motor, a connector, a weight sensor, and a powder storage bag.

The sealing device and the second rotary motor are mounted on the base, and the scaling device is located above the second rotary motor.

The weight sensor is configured to detect whether the weight of the powder storage bag reaches a preset value or not and sends the signals to the controller, which is connected to the sealing device and the second rotary motor.

The powder storage bag is connected to the second rotary motor through the connector. The second rotary motor rotates the powder storage bag to the lower part of the sealing device, and the sealing device is configured to seal the powder storage bag.

A horizontally arranged rail is provided on the printing platform. The vertical support frame is installed on the rail to move horizontally.

A recovery method for a selective laser melting gradient powder recovery device includes the following steps:

Powder suction: After laser printing, the ultrasonic powder suction device is moved above the forming cylinder for powder suction. Simultaneously, the waste material recovery device is activated to absorb the un-melted powder into the screening device through the powder delivery pipe.

Cooling: When the un-melted powders pass through the helical powder delivery pipe, the metal powder sensor detects whether the powder texture inside the helical powder delivery pipe is metallic or not and sends a signal to the controller. If the powder is metallic, the cooling device is activated to cool the powder inside the helical powder delivery pipe. Otherwise, the powders are directly delivered into the screening device.

Recovery: After the powders have been processed by the screening device, the powders in the lowest area of the screening device are delivered into the powder storage bag. The powders in other regions are recovered to the waste material recovery device.

After the powder recovery is completed, the ultrasonic powder suction device is moved away from the forming cylinder and will be put into the next printing of another type of powders. After the printing is finished, the above steps of powder suction, cooling, and recovery are repeated until the part is printed.

A recovery method for a selective laser melting gradient powder recovery device includes vacuum sealing steps:
vacuumizing the vacuum box by the first vacuum pump;
detecting by the weight sensor whether the weight of the powder storage bag reaches a preset value and sending a signal to the controller, which controls the second rotary motor to rotate the powder storage bag below the sealing device, and sealing the powder storage bag by the sealing device.

Compared with the existing technology, the beneficial effects of the present disclosure are:

According to one object of the present disclosure, the selective laser melting gradient powder device can separate and screen the gradient powders, and reduce the contact with air by operating in vacuum, increase the recycling rate of powders by reducing manual operations, and effectively prevent mixing and adhesion of different powders.

According to another aspect of the present disclosure, the use of an ultrasonic powder suction device can clean the un-melted powders inside the forming cylinder omni-directional and multi-perspective, effectively preventing mixing of different powders and increasing the powder recycling rate.

According to another aspect of the present disclosure, a metal powder sensor is provided in a spiral powder conveying tube to automatically identify metal powder, and a cooling device is utilized to reduce the risk of metal powder explosion.

According to another aspect of the present disclosure, a vacuum box is provided, in which powder bags for storing and recycling powders are automatically sealed, reducing contact with air, increasing the efficiency of powder recycling, and avoiding health hazards to workers caused by direct contact with powders.

It should be noted that the disclosure of these objects does not preclude the existence of other objects. One object of the present disclosure does not need to achieve all the above objects. Other objects of the present disclosure may be extracted from the specification, drawings, and claims.

### BRIEF DESCRIPTION OF THE DRAWINGS

FIG. 1 is a schematic diagram of the selective laser melting gradient powder recovery device of the present disclosure.

FIG. 2 is a three-dimensional model of the selective laser melting gradient powder recovery device of the present disclosure.

FIG. 3 is a schematic diagram of the ultrasonic powder suction device of the present disclosure.

FIG. 4 is a schematic diagram of the vibrating screen of the present disclosure.

In the figures, 1. ultrasonic powder suction device; 101. the first rotary motor; 102. the first telescopic motor; 103. the first suction hood; 104. flat suction head; 105. ultrasonic transducer; 106. ultrasonic generator; 107. the second suction hood, 108. sleeve; 109. the second telescopic motor; 2. vertical support frame; 3. printing platform; 4. forming cylinder; 5. the first vacuum pump; 6. sealing device; 7. the second rotary motor; 8. connector; 9. vacuum box; 10. vibrating screen; 1001. feeding inlet; 1002. the first waste outlet; 1003. discharge outlet; 1004. vibration motor; 1005. the first screen; 1006. the second screen; 1007. shell; 1008. the second waste outlet; 11. waste bin; 12. the second vacuum pump; 13. powder conveying pipe; 14. cooling device; 15. water tank; 16. spiral powder conveying pipe.

### DETAILED DESCRIPTION OF THE EMBODIMENTS

Reference will now be made in detail to present embodiments of the invention, one or more examples of which are illustrated in the accompanying drawings. The detailed description uses numerical and letter designations in the drawings and description have been used to refer to like or similar parts of the invention.

Each example is provided by way of explanation of the invention, not limitation of the invention. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

In the description of the present disclosure, it should be understood that the terms “center”, “longitudinal”, “horizontal”, “length”, “width”, “thickness”, “up”, “down”, “axial”, “radial”, “horizontal”, “vertical”, “internal”, “external”, and the like indicating direction or positional relationships are based on the directions or positional relationships shown in the figures, and are only used to facilitate the description of the present disclosure and simplify the description, rather than indicating or implying that the device or element referred to must have a specific orientation, must be constructed or operated in a specific orientation. Therefore, it should not be understood as limiting the present disclosure. In addition, the terms “first” and “second” are used only for the purpose of describing and do not indicate or imply relative importance or a specific number of technical features. Therefore, features labeled with “first” or “second” may include one or more features, either explicitly or implicitly. In the description of the present disclosure, the term “multiple” means two or more, unless otherwise specified.

In the present disclosure, unless otherwise specifically defined and limited, terms such as “installation”, “connection”, “fixing”, should be broadly interpreted. For example, they may refer to fixed or detachable connections, mechanical or electrical connections, direct or indirect connections through intermediate media, or internal communication between two components. Ordinary skilled persons in the art can understand the specific meaning of these terms in the present disclosure according to the specific situation.

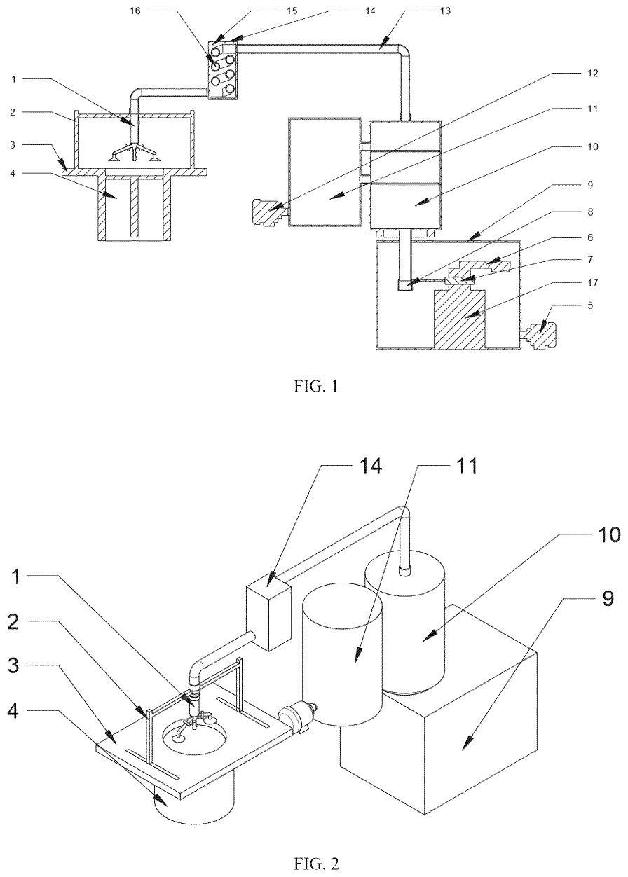

FIG. 1 shows a preferred embodiment of the selective laser melting gradient powder recovery device, which includes an ultrasonic powder suction device 1, a vertical support frame 2, a screening device 10, a powder conveying pipe 13, a cooling device 14, and a controller.

As shown in FIG. 2, the ultrasonic powder suction device 1 is mounted on the vertical support frame 2. The vertical support frame 2 is mounted on the printing platform 3. The top of the screening device 10 is connected to the ultrasonic powder suction device 1 through the powder conveying pipe 13, which has a helical powder conveying pipe 16 with a cooling device 14. A metal powder sensor is installed in the helical powder conveying pipe 16, which is configured to detect whether the powder texture in the helical powder conveying pipe 16 is metallic or not and send signals to the controller.

At least one screen mesh is installed inside the screening device 10 to divide the shell 1007 into at least two areas, with the upper area connected to the waste material recovery device and the lowest area to the powder storage bag.

The controller is connected to the ultrasonic powder suction device 1, screening device 10, waste material recovery device, metal powder sensor, and cooling device 14, respectively.

Preferably, the forming cylinder 4 is made of high temperature resistant material.

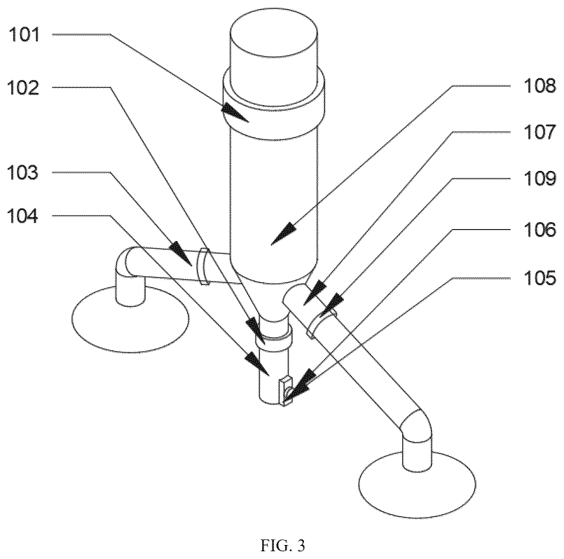

As shown in FIG. 3, the ultrasonic powder suction device 1 includes the first rotary motor 101, the first telescopic motor 102, at least one suction hood, a flat powder suction head 104, an ultrasonic transducer 105, an ultrasonic generator 106, and a sleeve 108.

The first rotary motor 101 is connected to the upper part of the sleeve 108 to drive the sleeve 108 to rotate. The flat powder suction head 104 is connected to the lower part of the sleeve 108, and the telescopic motor 102 is connected to the flat powder suction head 104 to drive it to move up and down. The ultrasonic transducer 105 is installed on the flat powder suction head 104, and the ultrasonic transducer 105 is equipped with an ultrasonic generator 106. The suction hood is connected to the sleeve 108 through the suction pipe, which is connected to the second telescopic motor 109, and the second telescopic motor 109 is configured to drive the expansion and contraction of the suction pipe.

Preferably, the suction hood includes the first suction hood 103 and the second suction hood 107, which are installed on both sides of the sleeve 108, respectively.

Preferably, the model of the ultrasonic generator 106 is JCC-2 or others, and the model of the ultrasonic transducer 105 is SL-HF.

Preferably, the cooling device 14 includes a water tank 15 and a water pipe. The helical powder conveying pipe 16 is located inside the water tank 15, and both ends of the helical powder conveying pipe 16 are connected to the powder conveying pipe 13. The water tank 15 is connected to the water pipe. A valve is provided on the water pipe, which is connected to the controller.

Preferably, the helical powder conveying pipe 16 and the water tank 15 are made of flame-retardant polystyrene high-temperature resistant materials with good flame-retardant performance. The metal powder sensor is installed in the helical powder conveying pipe 16 to detect the texture of the powder in the pipe 16 in real-time. When the metal sensor at the entrance of the powder conveying pipe 13 detects the metal powder, the cooling device 14 is turned on. Otherwise, the powder will be directly delivered into the screening device 10.

Preferably, the metal powder sensor is installed at the forefront of the spiral powder conveying pipe 16, and the spiral design of the helical powder conveying pipe 16 is to prolong the flow time of the powder in the pipeline and improve the cooling effect. The shape of the water tank 15 is rectangular, and the cooling device 14 is located above the printing platform 3.

Preferably, the screening device 10 includes a shell 1007 and a vibration motor 1004.

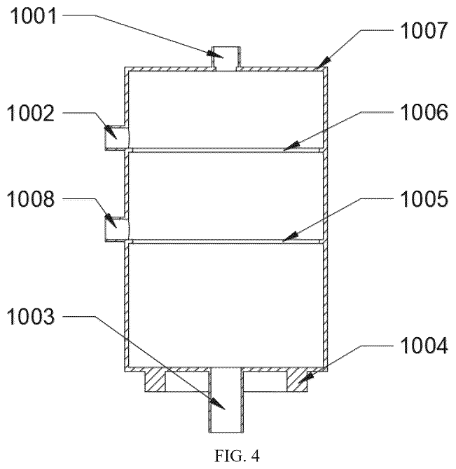

As shown in FIG. 4, the shell 1007 is set with the first screen mesh 1005 and the second screen mesh 1006, dividing the shell 1007 into the first area, the second area, and the third area from top to bottom, and the bore diameter of the first screen mesh 1005 is larger than that of the second screen mesh 1006. The top of the shell 1007 is provided with a feed inlet 1001. The shell 1007 has the first waste material outlet 1002 at the position of the first area and the second waste material outlet 1008 in the second area. The bottom of the shell 1007 is provided with a discharge outlet 1003, which is connected to the powder storage bag. The vibration motor 1104 is mounted on the shell 1007.

Preferably, the first screen mesh 1005 and the second screen mesh 1006 are located at one-third and two-thirds of the height of the shell 1007, respectively. The first screen mesh 1005 is located below the second screen mesh 1006, dividing the interior of the shell 1007 into three parts: a screening area (i.e., the first region), a transition area (i.e., the second region), and a qualified product area (i.e., the third region). Preferably, both the first screen mesh 1005 and the second screen mesh 1006 are circular in shape. The inlet 1001 is in the screening area, the waste outlet 1002 is in the screening area and the transition area, and the outlet 1003 is located at the qualified product area. Preferably, the inlet 1001, waste outlet 1002, and outlet 1003 are all cylindrical and connected to the powder conveying pipe 13 via a threaded connection. Preferably, the interior of the shell 1007 is cylindrical. The mesh diameters of the first screen mesh 1005 and the second screen mesh 1006 are 10-100 μm. The mesh diameters of the first screen mesh 1005 and the second screen mesh 1006 can be changed according to the particle size requirements of different powders, and the screens are detachably connected via threaded connections. The vibrating motor 1004 is preferably installed at the bottom of the shell 1007 via a threaded connection. The shell 1007 of the vibrating screen 10 is preferably cylindrical and made of metal material. The waste tank 11 is preferably equipped with an exhaust port on one side for connection to the second vacuum pump 12 via a threaded connection.

Preferred embodiments include a waste recycling device comprising a waste material tank 11 and the second vacuum pump 12.

The waste material tank 11 is connected to the first waste material outlet 1002 and the second waste material outlet 1008 of the screening device 10, and the second vacuum pump 12 is connected to the waste material tank 11.

Preferred embodiments further include a vacuum box 9.

The vacuum box 9 is connected to the first vacuum pump 5. The vacuum box 9 is equipped with a sealing device 6, the second rotary motor 7, a connector 8, a weight sensor, and a powder storage bag.

The sealing device 6 and the second rotary motor 7 are mounted on the base 17, and the sealing device 6 is located above the second rotary motor 7.

The connecting piece 8 includes a powder delivery pipe and two fixed rings that are mutually coordinated. The two fixed rings are mounted on the lower end of the powder delivery pipe to fix the powder storage bag, and the upper end of the powder delivery pipe is connected to the screening device 10.

The weight sensor is configured to detect whether the weight of the powder storage bag reaches a preset value or not and sends the signals to the controller, which is connected to the sealing device 6 and the second rotary motor 7.

The powder storage bag is connected to the second rotary motor 7 through the connector 8. The second rotary motor 7 rotates the powder storage bag to the lower part of the sealing device 6, and the sealing device 6 is configured to seal the powder storage bag.

Preferably, a horizontally arranged rail is provided on the printing platform 3. The vertical support frame 2 is installed on the rail to move horizontally.

The present disclosure relates to the selective laser melting gradient powder device, which can separate and screen the gradient powders, and reduce the contact with air by operating in vacuum, increase the recycling rate of powders by reducing manual operations, and effectively prevent mixing and adhesion of different powders. This makes it possible to manufacture gradient functional parts with different material compositions and effectively improve the performance of the parts in the SLM process.

The ultrasonic powder suction device can clean the un-melted powders inside the forming cylinder omni-directional and multi-perspective, effectively preventing mixing of different powders and increasing the powder recycling rate.

A metal powder sensor is provided in a spiral powder conveying tube 16 to automatically identify metal powder, and a cooling device is utilized to reduce the risk of metal powder explosion.

A vacuum box is provided, in which powder bags for storing and recycling powders are automatically sealed, reducing contact with air, increasing the efficiency of powder recycling, and avoiding health hazards to workers caused by direct contact with powders.

A recovery method for a selective laser melting gradient powder recovery device includes the following steps:

Powder suction: After laser printing, the ultrasonic powder suction device 1 is moved above the forming cylinder 4 for powder suction. Simultaneously, the waste material recovery device is activated to absorb the un-melted powder into the screening device 10 through the powder delivery pipe 13.

Cooling: When the un-melted powders pass through the spiral powder conveying tube 16, the metal powder sensor detects whether the powder texture inside the spiral powder conveying tube 16 is metallic or not and sends a signal to the controller. If the powder is metallic, the cooling device 14 is activated to cool the powder inside the spiral powder conveying tube 16. Otherwise, the powders are directly delivered into the screening device 10.

Recovery: After the powders have been processed by the screening device 10, the powders in the lowest area of the screening device 10 are delivered into the powder storage bag. The powders in other regions are recovered to the waste material recovery device.

After the powder recovery is completed, the ultrasonic powder suction device 1 is moved away from the forming cylinder 4 and will be put into the next printing of another type of powders. After the printing is finished, the above steps of powder suction, cooling, and recovery are repeated until the part is printed.

A recovery method for a selective laser melting gradient powder recovery device includes vacuum sealing steps:

The first vacuum pump 5 vacuumizes the vacuum box 9.

The weight sensor detects whether the weight of the powder storage bag reaches a preset value and sends a signal to the controller, which controls the second rotary motor 7 to rotate the powder storage bag below the sealing device 6. And the sealing device 6 seals the powder storage bag.

### Working Principle:

After laser printing, the ultrasonic powder suction device 1 is moved above the forming cylinder 4 for powder suction. When the ultrasonic powder suction device 1 is in operation, the first powder suction hood 103 and the second powder suction hood 107 adsorb the un-melted powder in the molding cylinder 4. Then, the height position of the flat powder suction head 104 is adjusted by the micro-motion telescopic motor 102 so that it can adsorb the remaining powder in the molding cylinder. Finally, the ultrasonic transducer 105 converts the input electrical power into mechanical power, which is emitted into the molding cylinder 4 by the ultrasonic generator 106, preventing the powder from adhering to the molding cylinder 4 or the part. After the powder enters the spiral powder conveying pipe 16, the metal powder sensor detects whether the powder texture inside the spiral powder conveying tube 16 is metallic or not. If the powder is metallic, the cooling device 14 is activated to cool the powder inside the spiral powder conveying tube 16. Otherwise, the powders are directly delivered into the screening device 10. The vibrating screen 10 passes the powders adsorbed by the ultrasonic powder suction device 1 through the feeding port 1001 into the screening area. At the same time, the vibrating motor 1004 at the bottom of shell 1007 is turned on to vibrate the powders through the first screen 1005 into the transition zone, and then the vibrating motor 1004 is turned on again to make the powders pass through the second screen 1006 into the qualified area. After two rounds of vibrating screening, the unqualified powders or residue are left in the screening area and transition zone. The unqualified powders are collected in the waste bin 11 by turning on the second vacuum pump 12, while the qualified powders are delivered into the qualified area. Meanwhile, the first vacuum pump 5 is turned on to allow the powders in the qualified area to pass through the discharge outlet 1003 into the next stage. The first vacuum pump 5 is turned on to create a vacuum in the vacuum box 9. And the powder bag starts to receive the qualified powder in the qualified area of the vibrating screen 10. When the powder bag is filled with a certain amount of qualified powder, the powder receiving is suspended. The second rotary motor 7 is turned on to place the powder bag under the sealing device 6, and the sealing device 6 seals the powder bag. After sealing is completed, a new powder bag is replaced to receive new powders. Repeat the above operation thereafter.

This invention comprehensively cleans the un-melted powder in the molding cylinder 4, including the powders remaining in the gaps of the molding cylinder 4 and some powders that are difficult to remove, effectively reducing the mixing of gradient powder and improving the recovery rate of gradient powder with different compositions. This invention effectively reduces the risk of metal powder explosion through the cooling device's cooling. By multiple vibration screenings, this invention screens out the optimal gradient powders and improves effectively the recovery utilization rate of gradient powders. The operation of this invention is simple, highly controllable, and highly automated, with easy-to-implement operating conditions, effectively avoiding the mixing and adhesion of different powders, reducing contact with air, increasing the efficiency of powder recycling, and avoiding health hazards to workers caused by direct contact with powders.

### Specific Example 1

The pure Fe powders and Nb powders are dried for 4 hours.

The printing platform 3 and the forming cylinder 4 are cleaned with a powerful vacuum cleaner.

A cube with dimensions of 10×10×10 mm is printed by SLM, with the upper 5 mm composed of Nb powders and the lower 5 mm composed of Fe powders.

The laser beam paths on computer software for SLM printing are set, with the laser beam rotating 679 per layer, a hatch distance of 0.08 mm, a scan speed of 800 mm/s, a laser power of 300 W, a spot diameter of 0.1 mm, argon gas as the protective gas, and a water and oxygen content during printing of no more than 30 ppm. The model data of the SLM printed cube is input.

Before selective laser melting, the adhesiveness of the powder is determined. Both pure element Fe powders and Nb powders have low adhesiveness.

Fe powders are added to the powder storage bin in the SLM equipment.

It is time to vacuum, then the printing process starts when the water and oxygen content in the SLM equipment drops to 30 ppm.

After laser printing, the ultrasonic powder suction device 1 is moved above the forming cylinder 4 for powder suction. Because the Fe powders have low adhesion, they can be cleaned with normal adsorption. The un-melted powders are absorbed into the screening device 10 through the powder delivery pipe 13.

At the same time, the metal powder sensor in the helical powder delivery pipe 16 will automatically identify the powders. If the powder is metallic, the cooling device 14 will be activated. Otherwise, the powders are directly delivered into the screening device 10.

After the powders have been processed by the screening device 10, the residue collection device will clean up the larger waste particles in the vibrating screen 10. While the recyclable powders will be delivered into the powder storage bag.

After the Fe powders recovery work is completed, the ultrasonic powder suction device 1 is moved away from the forming cylinder.

A powerful vacuum cleaner is configured to clean the powder storage bin after turning on the SLM equipment.

After the cleaning work is completed, Nb powders are added to the powder storage bin in the SLM equipment.

It is time to vacuum, then the printing process starts when the water and oxygen content in the SLM equipment drops to 30 ppm.

After laser printing, the ultrasonic powder suction device 1 is moved above the forming cylinder 4 for powder suction. Because the Nb powders have low adhesion, they can be cleaned with normal adsorption. The un-melted powders are absorbed into the screening device 10 through the powder delivery pipe 13.

At the same time, the metal powder sensor in the helical powder delivery pipe 16 will automatically identify the powders. If the powder is metallic, the cooling device 14 will be activated. Otherwise, the powders are directly delivered into the screening device 10.

After the powders have been processed by the screening device 10, the residue collection device will clean up the larger waste particles in the vibrating screen 10. While the recyclable powders will be delivered into the powder storage bag.

After the printing and powder recovery work are completed, the SLM equipment is turned off and the substrate is cooled overnight. The next day, the substrate, printed model, and recovered powder are taken out to complete the recycling selectively laser melted gradient powders.

### Specific Example 2

Ti alloy powders and pure Nb powders are dried for 4 hours.

The printing platform 3 and the forming cylinder 4 are cleaned with a powerful vacuum cleaner.

A cube with dimensions of 10×10×10 mm is printed by SLM, with the upper 5 mm composed of Nb powders and the lower 5 mm composed of Ti alloy powders.

The laser beam paths on computer software for SLM printing are set, with the laser beam rotating 67° per layer, a hatch distance of 0.08 mm, a scan speed of 1000 mm/s, a laser power of 200 W, a spot diameter of 0.1 mm, argon gas as the protective gas, and a water and oxygen content during printing of no more than 30 ppm. The model data of the SLM printed cube is input.

Before selective laser melting, the adhesiveness of the powder is determined. Ti alloy powders have higher adhesiveness, while pure element Nb powder has lower adhesiveness.

Ti alloy powders are added to the powder storage bin in the SLM equipment.

It is time to vacuum, then the printing process starts when the water and oxygen content in the SLM equipment drops to 30 ppm.

After laser printing, the ultrasonic powder suction device 1 is moved above the forming cylinder 4 for powder suction. Because the Ti alloy powders have high adhesion, while absorbing powders the ultrasonic emitter is turned on to emit ultrasound waves in order to make the Ti alloy powders adhered to the forming cylinder automatically detach. They can be absorbed by the powder suction head. And the un-melted powders are absorbed into the screening device 10 through the powder delivery pipe 13.

At the same time, the metal powder sensor in the helical powder delivery pipe 16 will automatically identify the powders. If the powder is metallic, the cooling device 14 will be activated. Otherwise, the powders are directly delivered into the screening device 10.

After the powders have been processed by the screening device 10, the residue collection device will clean up the larger waste particles in the vibrating screen 10. While the recyclable powders will be delivered into the powder storage bag.

After the Ti alloy powders recovery work is completed, the ultrasonic powder suction device 1 is moved away from the forming cylinder.

A powerful vacuum cleaner is configured to clean the powder storage bin after turning on the SLM equipment.

After the cleaning work is completed, Nb powders are added to the powder storage bin in the SLM equipment.

It is time to vacuum, then the printing process starts when the water and oxygen content in the SLM equipment drops to 30 ppm.

After laser printing, the ultrasonic powder suction device 1 is moved above the forming cylinder 4 for powder suction. Because the Nb powders have low adhesion, they can be cleaned with normal adsorption. The un-melted powders are absorbed into the screening device 10 through the powder delivery pipe 13.

At the same time, the metal powder sensor in the helical powder delivery pipe 16 will automatically identify the powders. If the powder is metallic, the cooling device 14 will be activated. Otherwise, the powders are directly delivered into the screening device 10.

After the powders have been processed by the screening device 10, the residue collection device will clean up the larger waste particles in the vibrating screen 10. While the recyclable powders will be delivered into the powder storage bag.

After the printing and powder recovery work are completed, the SLM equipment is turned off and the substrate is cooled overnight. The next day, the substrate, printed model, and recovered powder are taken out to complete the recycling selectively laser melted gradient powders.

### Specific Example 3

Ti alloy powders and pure C powders are dried for 4 hours.

The printing platform 3 and the forming cylinder 4 are cleaned with a powerful vacuum cleaner.

A cube with dimensions of 10×10×10 mm is printed by SLM, with the upper 5 mm composed of C powders and the lower 5 mm composed of Ti alloy powders.

The laser beam paths on computer software for SLM printing are set, with the laser beam rotating 67° per layer, a hatch distance of 0.08 mm, a scan speed of 1250 mm/s, a laser power of 120 W, a spot diameter of 0.1 mm, argon gas as the protective gas, and a water and oxygen content during printing of no more than 30 ppm. The model data of the SLM printed cube is input.

Before selective laser melting, the adhesiveness of the powder is determined. Both Ti alloy powders and pure element C powders have higher adhesiveness.

Ti alloy powders are added to the powder storage bin in the SLM equipment.

It is time to vacuum, then the printing process starts when the water and oxygen content in the SLM equipment drops to 30 ppm.

After laser printing, the ultrasonic powder suction device 1 is moved above the forming cylinder 4 for powder suction. Because the Ti alloy powders have high adhesion, while absorbing powders the ultrasonic emitter is turned on to emit ultrasound waves in order to make the Ti alloy powders adhered to the forming cylinder automatically detach. They can be absorbed by the powder suction head. And the un-melted powders are absorbed into the screening device 10 through the powder delivery pipe 13.

At the same time, the metal powder sensor in the helical powder delivery pipe 16 will automatically identify the powders. If the powder is metallic, the cooling device 14 will be activated. Otherwise, the powders are directly delivered into the screening device 10.

After the powders have been processed by the screening device 10, the residue collection device will clean up the larger waste particles in the vibrating screen 10. While the recyclable powders will be delivered into the powder storage bag.

After the Ti alloy powders recovery work is completed, the ultrasonic powder suction device 1 is moved away from the forming cylinder.

A powerful vacuum cleaner is configured to clean the powder storage bin after turning on the SLM equipment.

After the cleaning work is completed, C powders are added to the powder storage bin in the SLM equipment.

It is time to vacuum, then the printing process starts when the water and oxygen content in the SLM equipment drops to 30 ppm.

After laser printing, the ultrasonic powder suction device 1 is moved above the forming cylinder 4 for powder suction. Because the C powders have high adhesion, while absorbing powders the ultrasonic emitter is turned on to emit ultrasound waves in order to make the C powders adhered to the forming cylinder automatically detach. They can be absorbed by the powder suction head. And the un-melted powders are absorbed into the screening device 10 through the powder delivery pipe 13.

At the same time, the metal powder sensor in the helical powder delivery pipe 16 will automatically identify the powders. If the powder is metallic, the cooling device 14 will be activated. Otherwise, the powders are directly delivered into the screening device 10.

After the powders have been processed by the screening device 10, the residue collection device will clean up the larger waste particles in the vibrating screen 10. While the recyclable powders will be delivered into the powder storage bag.

After the printing and powder recovery work are completed, the SLM equipment is turned off and the substrate is cooled overnight. The next day, the substrate, printed model, and recovered powder are taken out to complete the recycling selectively laser melted gradient powders.

The powders in the above implementation examples 1-3 can be effectively recovered.

The above disclosure is merely a preferred example of the present disclosure, and certainly cannot be used to limit the scope of the present disclosure. Therefore, equivalent changes made according to the claims of the present disclosure shall still belong to the scope of the present disclosure.

1. A selective laser melting gradient powder recovery device, comprising an ultrasonic powder suction device (1), a vertical support frame (2), a screening device (10), a waste material recovery device, a powder conveying pipe (13), a cooling device (14), and a controller,
wherein the ultrasonic powder suction device (1) is mounted on the vertical support frame (2); the vertical support frame (2) is mounted on the printing platform (3); a top of the screening device (10) is connected to the ultrasonic powder suction device (1) through the powder conveying pipe (13), which has a helical powder conveying pipe (16) with a cooling device (14); a metal powder sensor is installed in the helical powder conveying pipe (16), which is configured to detect whether the powder texture in the helical powder conveying pipe (16) is metallic or not and send signals to the controller;
at least one screen mesh is installed inside the screening device (10) to divide the shell (1007) into at least two areas, with an upper area connected to the waste material recovery device and a lowest area to a powder storage bag; and
the controller is connected to the ultrasonic powder suction device (1), the screening device (10), the waste material recovery device, the metal powder sensor, and cooling device (14), respectively.

2. The selective laser melting gradient powder recovery device according to claim 1, wherein the ultrasonic powder suction device (1) comprises a first rotary motor (101), a first telescopic motor (102), at least one suction hood, a flat powder suction head (104), an ultrasonic transducer (105), an ultrasonic generator (106), and a sleeve (108);
the first rotary motor (101) is connected to the upper part of the sleeve (108) to drive the sleeve (108) to rotate; the flat powder suction head (104) is connected to the lower part of the sleeve (108), and the telescopic motor (102) is connected to the flat powder suction head (104) to drive it to move up and down; the ultrasonic transducer (105) is installed on the flat powder suction head (104), and the ultrasonic transducer (105) is equipped with an ultrasonic generator (106); and the suction hood is connected to the sleeve (108) through the suction pipe, which is connected to the second telescopic motor (109), and the second telescopic motor (109) is configured to drive the expansion and contraction of the suction pipe.

3. The selective laser melting gradient powder recovery device according to claim 2, wherein the suction hood comprises a first suction hood (103) and a second suction hood (107), which are installed on both sides of the sleeve (108), respectively.

4. The selective laser melting gradient powder recovery device according to claim 1, wherein the cooling device (14) comprises a water tank (15) and a water pipe; the helical powder conveying pipe (16) is located inside the water tank (15), and both ends of the helical powder conveying pipe (16) are connected to the powder conveying pipe (13); the water tank (15) is connected to the water pipe; and a valve is provided on the water pipe, which is connected to the controller.

5. The selective laser melting gradient powder recovery device according to claim 1, wherein the screening device (10) comprises a shell (1007) and a vibration motor (1004); and
the shell (1007) is set with the first screen mesh (1005) and the second screen mesh (1006), dividing the shell (1007) into a first area, a second area, and a third area from top to bottom, and a bore diameter of the first screen mesh (1005) is larger than that of the second screen mesh (1006); a top of the shell (1007) is provided with a feed inlet (1001); the shell (1007) has a first waste material outlet (1002) at a position of the first area and a second waste material outlet (1008) in the second area; and a bottom of the shell (1007) is provided with a discharge outlet (1003), which is connected to the powder storage bag; and the vibration motor (1104) is mounted on the shell (1007).

6. The selective laser melting gradient powder recovery device according to claim 1, wherein the waste material recovery device comprises a waste material tank (11) and a second vacuum pump (12); and
the waste material tank (11) is connected to the first waste material outlet (1002) and the second waste material outlet (1008) of the screening device (10), and the second vacuum pump (12) is connected to the waste material tank (11).

7. The selective laser melting gradient powder recovery device according to claim 1, comprising a vacuum box (9);
the vacuum box (9) is connected to a first vacuum pump (5); the vacuum box (9) is equipped with a sealing device (6), the second rotary motor (7), a connector (8), a weight sensor, and a powder storage bag,
the sealing device (6) and the second rotary motor (7) are mounted on the base (17), and the sealing device (6) is located above the second rotary motor (7);
the weight sensor is configured to detect whether the weight of the powder storage bag reaches a preset value or not and sends the signals to the controller, which is connected to the sealing device (6) and the second rotary motor (7); and
the powder storage bag is connected to the second rotary motor (7) through the connector (8); the second rotary motor (7) rotates the powder storage bag to the lower part of the sealing device (6), and the sealing device (6) is configured to seal the powder storage bag.

8. The selective laser melting gradient powder recovery device according to claim 1, wherein a horizontally arranged rail is provided on the printing platform (3), and the vertical support frame (2) is installed on the rail to move horizontally.

9. A recovery method for a selective laser melting gradient powder recovery device according to any one of claims 1-8, comprising the following steps:
powder suction: after laser printing, the ultrasonic powder suction device (1) is moved above the forming cylinder (4) for powder suction; simultaneously, the waste material recovery device is activated to absorb the un-melted powder into the screening device (10) through the powder delivery pipe (13);
cooling: when the un-melted powders pass through the helical powder delivery pipe (16), the metal powder sensor detects whether the powder texture inside the helical powder delivery pipe (16) is metallic or not and sends a signal to the controller; if the powder is metallic, the cooling device (14) is activated to cool the powder inside the helical powder delivery pipe (16); otherwise, the powders are directly delivered into the screening device (10);
recovery: after the powders have been processed by the screening device (10), the powders in the lowest area of the screening device (10) are delivered into the powder storage bag; the powders in other regions are recovered to the waste material recovery device; and
after the powder recovery is completed, the ultrasonic powder suction device (1) is moved away from the forming cylinder (4) and will be put into the next printing of another type of powders; and after the printing is finished, the above steps of powder suction, cooling, and recovery are repeated until the part is printed.

10. A recovery method for a selective laser melting gradient powder recovery device according to claim 9, comprising vacuum sealing steps:
vacuumizing the vacuum box (9) by the first vacuum pump (5); and
detecting by the weight sensor whether the weight of the powder storage bag reaches a preset value and sending a signal to the controller, which controls the second rotary motor (7) to rotate the powder storage bag below the sealing device (6), and sealing the powder storage bag by the sealing device (6).
